(19) United States
(12) Patent Application Publication
(10) Pub. No.: US 2012/0051583 A1
(43) Pub. Date: Mar. 1, 2012

(54) SOFT ERROR VERIFICATION IN HARDWARE DESIGNS

(75) Inventors: David Amid, Kiryat Ata (IL); Ateret Anaby-Tavor, Givat Ada (IL); Avivit Bercovich, Atlit (IL); Michael Desmond, White Plains, NY (US); Amit Fisher, Nofit (IL); Harold Leon Ossher, South Salem, NY (US); Ian David Simmonds, Dobbs Ferry, NY (US)

(73) Assignee: International Business Machines Corporation, Armonk, NY (US)

(21) Appl. No.: 12/868,751

(22) Filed: Aug. 26, 2010

(51) Int. Cl. G06K 9/00

(52) U.S. Cl. 382/100

(57) ABSTRACT

A method of determining whether a given diagram is a conceptual model is provided. The method may include the following steps: obtaining a plurality of artifacts, wherein each one of the artifacts exhibits at least one diagram, and wherein at least some of the artifacts exhibit text associated with the diagrams; determining for each diagram, a plurality of specified factors; and estimating, for each diagram, a likelihood of the diagram being a conceptual model based at least partially on the determined factors. Optionally, the method may further include the step of applying a scoring function to the determined factors, to yield a score, wherein the estimating is further based on the score.

### BACKGROUND

1. Technical Field

The present invention relates to data processing and more particularly, to determining whether a given diagram is a conceptual model.

2. Discussion of the Related Art

The modern enterprise of today is facing an ongoing challenge in knowledge management as the amount of documents produced by these organizations increases exponentially. To be able to preserve and reuse intellectual capital in such organizations, by-products of the organization needs to be classified into documents which contain information which is relevant for harvesting and documents which do not.

Capturing intellectual capital in a reusable form is a key for enabling knowledge transfer within an organization. Currently, many organizations suffer from a knowledge transfer issue. The organization seeks to organize, create, capture, or distribute knowledge and ensure its availability for future users. It would be therefore advantageous to have a tool that enables an organization to evaluate the likelihood that a given document holds vital information regarding the data flow, processes, logic, and architecture of an organization.

### BRIEF SUMMARY

One aspect of the invention provides a method of determining whether a given diagram is a conceptual model. The method may include the following steps: obtaining a plurality of artifacts, wherein each one of the artifacts exhibits at least one diagram, and wherein at least some of the artifacts exhibit text associated with the diagrams; determining for each diagram, a plurality of specified factors; and estimating, for each diagram, a likelihood of the diagram being a conceptual model based at least partially on the determined factors. Optionally, the method may further include the step of applying a scoring function to the determined factors, to yield a score, wherein the estimating is further based on the score.

Other aspects of the invention may include a system arranged to execute the aforementioned method and a computer readable program configured to execute the aforementioned method. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating an environment of a system according to some embodiments of the invention;

FIG. 2 is a high level schematic block diagram illustrating the system according to some embodiments of the invention;

FIG. 3 is a high level flowchart diagram illustrating a method according to some embodiments of the invention;

FIG. 4 is an exemplary document illustrating an aspect according to some embodiments of the invention;

FIG. 5 is a Venn diagram illustrating the system according to some embodiments of the invention;

FIG. 6 is a table illustrating a method according to some embodiments of the invention; and

FIG. 7 is a table illustrating an aspect according to some embodiments of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “artifact” as used herein in this application refers to one of many kinds of tangible by-products produced during the work of business analysts, business architects, and solution consultants. These practitioners use a variety of practices and methods in their quest to understand business. The resulting work products could end up being transitioned into the formal world of software requirement definitions (e.g., use cases, class diagrams, and other Unified Model Language (UML) models, requirements and design documents) or as recommendations for all kinds of business activities and transformations (such as project plans, business cases, and risk assessments).

The term “model” as used herein in this application refers to anything used in any way to represent anything else. Some models are physical objects, for instance, a toy model which may be assembled, and may even be made to work like the object it represents. A “conceptual model” on the other hand, may only be drawn on paper, described in words, or imagined in the mind Conceptual models are used to help users know and understand the subject matter they represent.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

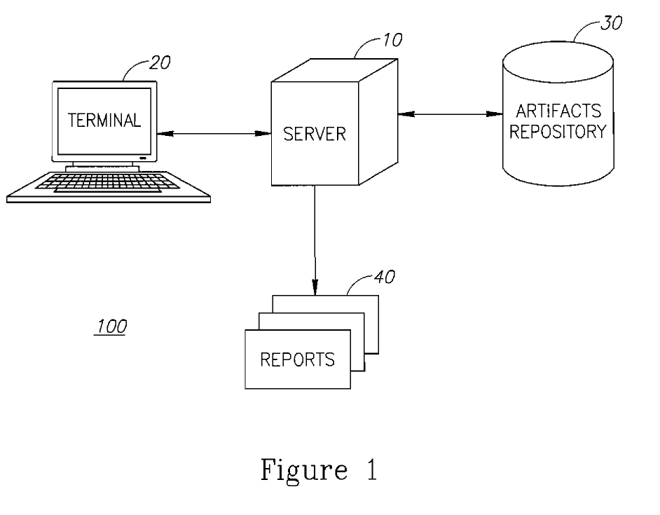

FIG. 1 is a high level schematic block diagram illustrating an exemplary environment of a system 100 according to some embodiments of the invention. System 100 may include a server 10 connected to a terminal 20 over a communication network. Server 10 may be further in operative association with an artifacts repository 30 that may contain a plurality of human generated documents of all kinds and forms, wherein the documents contain diagrams. These diagrams are classified by system 100 as will be explained below, possibly in a form of reports 40, into either conceptual models or simply drawings.

In an empirical study conducted by the applicants, the applicants have identified at least four factors that may be statistically related to whether a diagram is defined as a conceptual model or not. These factors are:

Method existence—relate to a situation in which the business stakeholder provides within the artifact, a detailed and unambiguous description of the constructs of the diagram, and a way of using them in the business circumstances. In such a situation, the diagram is likely to be a conceptual model.
Multiple interwoven diagrams—relate to a situation in which the artifact contain diagrams that relate to each other. Such a situation implies the diagrams are part of a multi-grammar conceptual model.
Standard manipulation—relate to a situation in which the diagram is a manipulation of a standard. Such a situation implies that the diagram reflects a conceptual model created by a variation of the standard's conceptual model; and
Repetitiveness—relate to a situation in which diagrams can be repeated with slight modifications and different data/text in the same artifact. If a diagram is repeated it implies the author has found this way of conveying a thought useful enough to be repeated in similar context.

When a diagram is presented as part of an artifact the method checks the existence of the different factors mentioned above and provides an estimate of a probabilistic nature, on whether the diagram represents a conceptual model or not.

Although system 100 is illustrated in a client-server configuration, it is understood that the aforementioned configuration is for illustration purposes only and other architectures may be used in order to implement system 100.

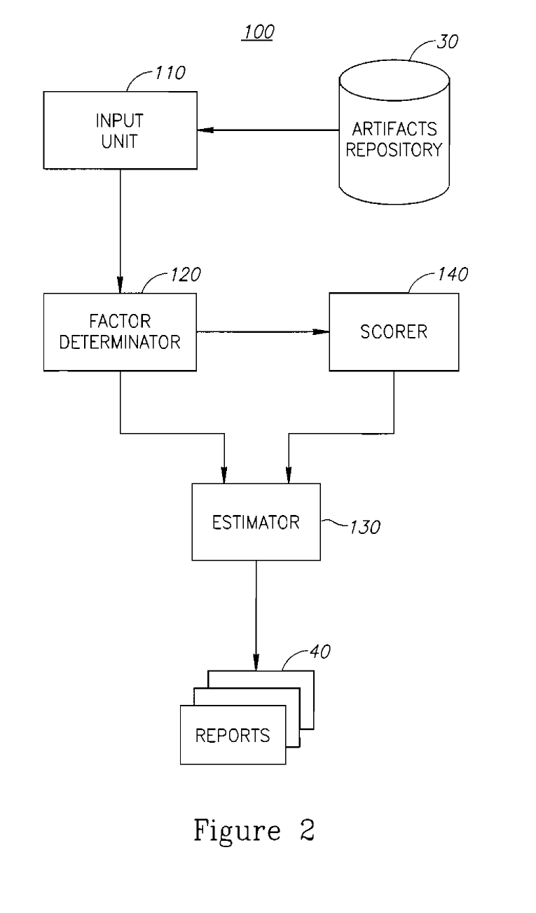

FIG. 2 is a high level schematic block diagram illustrating in further details the modules of system 100 according to some embodiments of the invention. system 100 may include an input unit 110 configured to obtain a plurality of artifacts from artifacts repository 30, wherein each one of the artifacts exhibits at least one diagram, and wherein at least some of the artifacts exhibit text associated with the diagrams. System 100 may further include a factor determinator 120 configured to determine, for each diagram, a plurality of specified factors. System 100 may further include an estimator 130 configured to estimate, for each diagram, a likelihood of the diagram being a conceptual model based at least partially on the determined factors. Input unit 110, factor determinator 120, and estimator 130 may be in operative association with a processor (not shown) that may be associated with server 10

Consistent with one embodiment of the invention, and as explained above in detail, the specified factors may comprise at least one of: whether the diagram is associated with a method, whether the diagram is a deviation from a specified standard diagram, whether specified features are repeated in a specified number of diagrams, and whether the diagram relate to other diagrams.

Consistent with one embodiment of the invention, system 100 may further include a scorer 140 configured to apply a scoring function to the determined factors, to yield a score, and wherein the estimator is further configured to base the estimation on the score.

Consistent with one embodiment of the invention, determining whether the diagram is associated with a method, may be executed by analyzing the text associated with the diagram on a common artifact to detect textual reference to the diagram associated with a specified logic or a flow.

Consistent with one embodiment of the invention, determining whether the diagram is a deviation from a specified standard diagram, may be executed by comparing the diagram with a knowledge base of standard diagram to detect consistent graphic transformation between the diagram and at least one of the standard diagrams.

Consistent with one embodiment of the invention, determining whether specified features are repeated in a specified number of diagrams, may be executed by comparing a plurality of diagrams to detect a plurality of graphical features that reoccur in number of diagrams beyond a specified threshold.

Consistent with one embodiment of the invention, determining whether the diagram graphically relates to other diagrams may be executed by comparing at least two diagrams associated with a common artifact to detect a graphic reference from at least one diagram to another diagram.

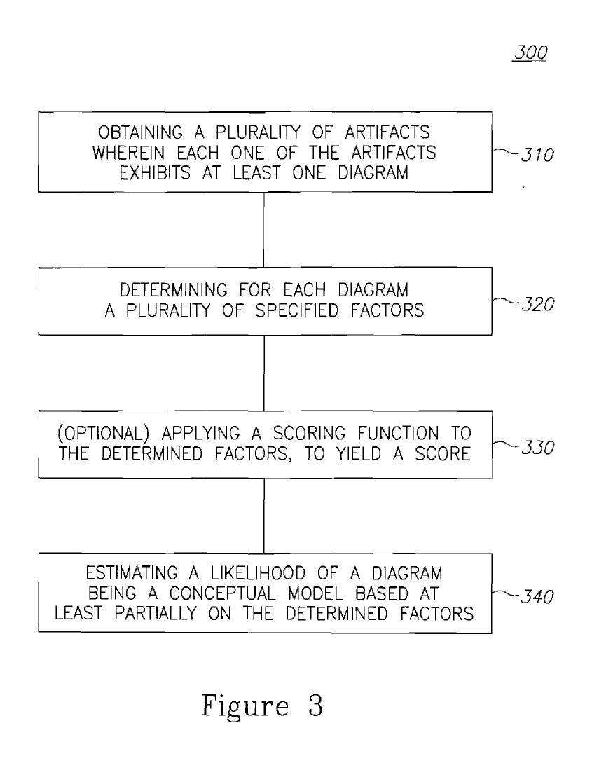

FIG. 3 is a high level flowchart diagram illustrating a method 300 according to some embodiments of the invention. Method 300 is a method of determining whether a given diagram is a conceptual model by analyzing each diagram according to specified factors previously derived from the aforementioned empirical study or similar empirical studies. Method 300 may start with the step of obtaining a plurality of artifacts from a data repository (e.g., from a database of an organization), wherein each one of the artifacts exhibits at least one diagram 310. The artifacts in the repository may exhibit text associated with the diagrams. Method 300 may go on to the step of determining for each diagram, a plurality of specified factors 320. Then, method 300 may include an optional step of applying a scoring function to the determined factors, to yield a score 330. Finally, method 300 may include the step of estimating, for each diagram, a likelihood of the diagram being a conceptual model based at least partially on the determined factors 340. In case a scoring function has been applied and a score has been calculated for each factor, the estimation is further based on the respective scores.

In order to implement method 300, a computer (not shown) may receive instructions and data from a read-only memory or a random access memory or both. At least one of aforementioned steps may be performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

Consistent with one embodiment of the invention, the specified factors may include any one of, or a combination of factors relating to: whether the diagram is associated with a method, whether the diagram is a deviation from a specified standard diagram, whether specified features are repeated in a specified number of diagrams, and whether the diagram relates to other diagrams. It is understood however that other factors may be used, the common point being a statistical relationship, possibly derived from empirical study, between the factors and the diagram being a conceptual model.

Consistent with one embodiment of the invention, determining whether the diagram is associated with a method, may be executed by analyzing the text associated with the diagram on a common artifact to detect textual reference to the diagram associated with a specified logic or a flow.

Consistent with one embodiment of the invention, determining whether the diagram is a deviation from a specified standard diagram may be executed by comparing the diagram with a knowledge base of standard diagram to detect consistent graphic transformation between the diagram and at least one of the standard diagrams.

Consistent with one embodiment of the invention, determining whether specified features are repeated in a specified number of diagrams may be executed by comparing a plurality of diagrams to detect a plurality of graphical features that reoccur in number of diagrams beyond a specified threshold.

Consistent with one embodiment of the invention, determining whether the diagram graphically relates to other diagrams is executed by comparing at least to diagram associated with a common artifact to detect a graphic reference from at least one diagram to another diagram.

The reminder of the description below relate to an exemplary empirical study of artifacts that contain diagrams. These diagrams were classified according to specific factors so that a statistic relationship between these factors and the likelihood of a diagram being a conceptual model may be derived. It is understood that the examples below are non-limiting and for illustrative purposes only. As explained above, other factors may be derived for determining in a probabilistic manner, whether a given diagram is either a conceptual model or a mere drawing.

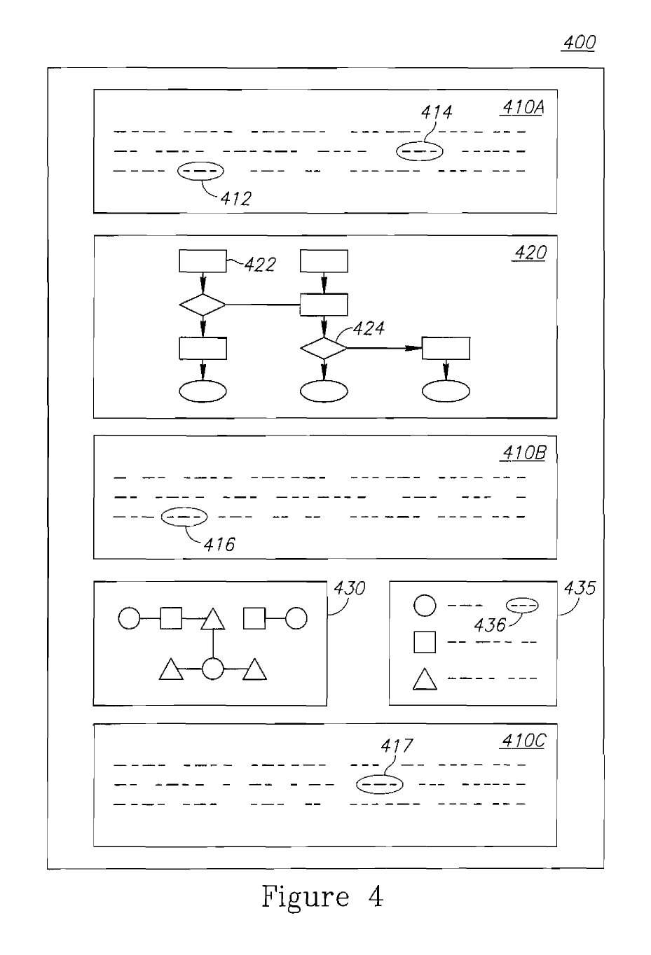

FIG. 4 is an exemplary document illustrating an aspect according to some embodiments of the invention. Exemplary artifact 400 may include several portions of text 410A-410C, a flowchart diagram 420, a block diagram 430 and a corresponding legend 435. Consistent with the aforementioned factors, specific terms in diagram 420 such as 422 and 424 may be traced in test portions 410A or 410B, for example in 412, 414, or 416. In a case of a block diagram 430, a legend 435 may be traced to find specific terminology such as 436 that may be later traced in one of the text portions, such as 417 in 410C. As explained above, the additional information regarding flowchart diagram 420 and block diagram 430 (compared with other diagram in artifact 400 or with text portions) may be used in the estimation process for determining whether the diagram is a conceptual model.

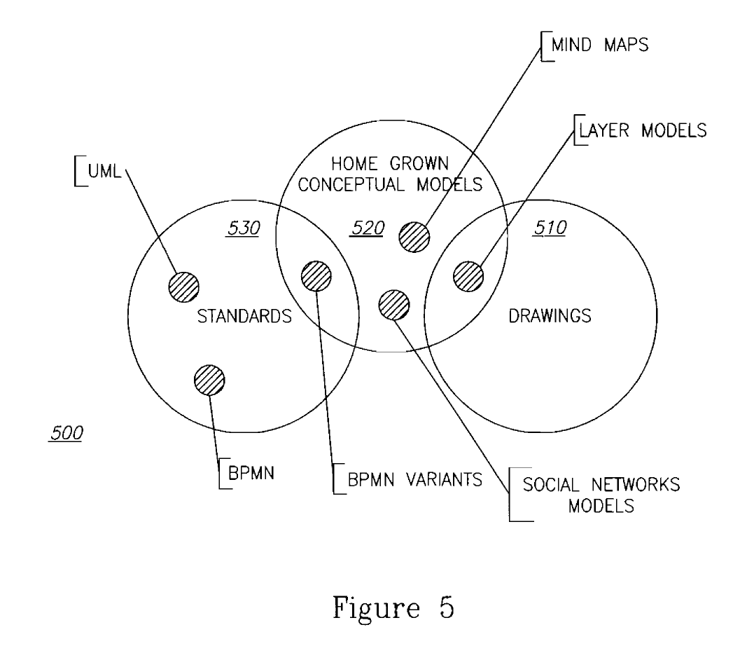

FIG. 5 is a Venn diagram illustrating the system according to some embodiments of the invention. Diagram 500 shows types of diagrams that may be classified into standards 530, home grown conceptual models (at start organization-specific, or industry specific when the standard is common to a plurality of organizations) 520 and mere drawings 510. As shown, there is a degree of overlapping between the three different classes. Since both standards 530 (such as Unified Modeling Language and Business Process Modeling Notation) and home grown conceptual models 520 (such as mind maps and layer models) are classified as conceptual models, the overlapping between these classes is less crucial.

On the other hand, the overlapping between drawings 510 and home grown conceptual models 520 such as with layer models, tend to pose a challenge on difficult cases of classification. These may be solved, consistent with embodiments of the invention, using statistical methods and creating thresholds accordingly.

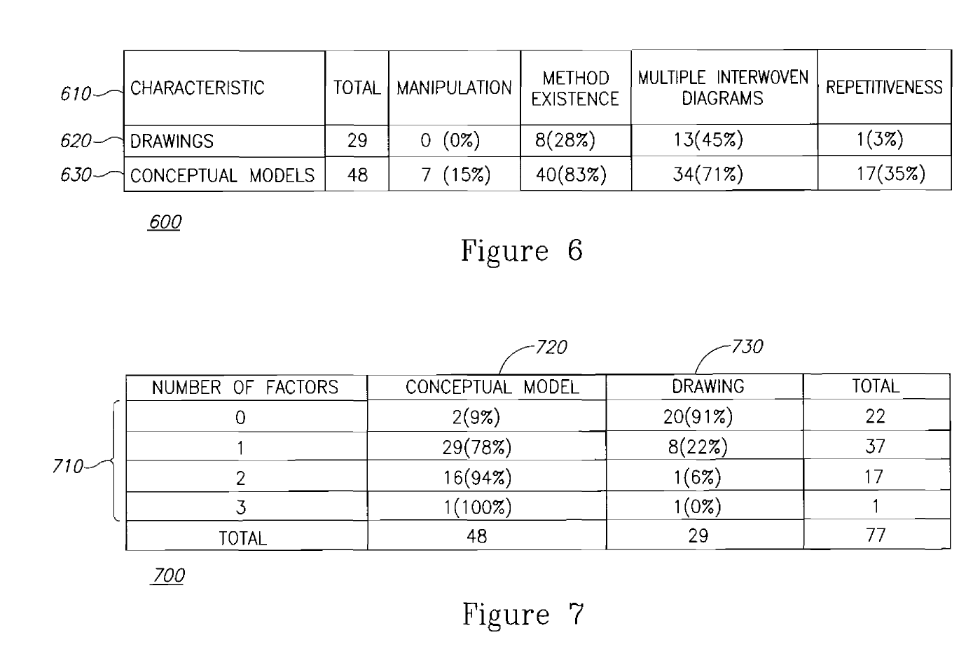

FIG. 6 is a table illustrating an aspect according to some embodiments of the invention. Table 600 illustrates the frequencies of occurrences of the selected aforementioned factors by characteristic for an illustrative repository of 77 artifacts that have been sampled in an empirical study conducted by the applicants. As shown in row 610, the diagrams are classified into the factors of: manipulation, method existence, multiple interwoven diagrams, and repetitiveness. Row 620 shows the number of drawings containing each of the aforementioned factors. The figures in parentheses exhibit the ratio between diagrams associated with the appropriate factor and the total diagrams in each characteristic category. Similarly, row 630 shows the number of conceptual model diagrams containing each of the aforementioned factors. The figures in parentheses exhibit the ratio between diagrams associated with the appropriate factor and the total diagrams in each characteristic category. As can be seen from table 600, for conceptual models in row 630, occurrence of any of the aforementioned factors increases the aforementioned ratio dramatically in comparison with the respective ratio for drawings in row 620. For example, 71% of the conceptual model diagrams exhibit the factor of multiple interwoven diagrams while only 45% of the drawing diagrams exhibit the factor of multiple interwoven diagrams. In addition, 35% of the conceptual model diagrams exhibit repetitiveness while only 3% of the drawing diagrams exhibit any degree of repetitiveness.

It should be noted that the factors “multiple interwoven diagrams” and “method existence” exhibit a statistic correlation therebetween. “Repetitiveness” and “manipulation” on the other hand, are unrelated. This type of statistical data may be used in determining thresholds differentiating conceptual model diagrams and mere drawings.

FIG. 7 is a table illustrating an aspect according to some embodiments of the invention. Table 700 illustrates the frequencies of the number of the aforementioned factors by characteristic vis à vis the classification of a given diagram as either a conceptual model or a mere drawing. Row 710 indicates the number of the aforementioned factors that have been identified in conjunction with a specified diagram in the aforementioned empirical study. Row 720 shows the number of conceptual models that have been identified having the corresponding number of factors of row 710 (the parentheses show the percentage of diagrams identified as conceptual models out of the sample in the study). Similarly, Row 730 shows the number of drawings that have been identified having the corresponding number of factors of row 710 (the parentheses show the percentage of diagrams identified as drawings out of the sample in the study). As clearly seen from table 700, the more of the aforementioned factors a diagram has, the more likely it is to be a conceptual model and vice versa.

The applicants have discovered in the aforementioned empirical study that the Cramer correlation coefficient yields a pronounced relationship between the characteristic of a diagram and the existence of the aforementioned factors, which is 0.707. Furthermore, the lambda correlation indicates that information about these three factors decreases the error in predicting the diagram's characteristic by 62.1%. These indicators show that the aforementioned factors are statistically sufficient, as shown above, for determining whether a given diagram is a conceptual model.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising:
obtaining a plurality of artifacts, wherein each one of the artifacts exhibits at least one diagram, and wherein at least some of the artifacts exhibit text associated with the diagrams;
determining for each diagram, a plurality of specified factors; and
estimating, for each diagram, a likelihood of the diagram being a conceptual model based at least partially on the determined factors,
wherein at least one of: the obtaining, the determining, and the estimating, is executed by at least one processor.

2. The method according to claim 1, wherein the specified factors comprise at least one of: whether the diagram is associated with a method, whether the diagram is a deviation from a specified standard diagram, whether specified features are repeated in a specified number of diagrams, and whether the diagram relates to other diagrams.

3. The method according to claim 1, further comprising applying a scoring function to the determined factors, to yield a score, wherein the estimating is further based on the score.

4. The method according to claim 2, wherein determining whether the diagram is associated with a method, is executed by analyzing the text associated with the diagram on a common artifact to detect textual reference to the diagram associated with a specified logic or a flow.

5. The method according to claim 2, wherein determining whether the diagram is a deviation from a specified standard diagram, is executed by comparing the diagram with a knowledge base of standard diagrams to detect consistent graphic transformation between the diagram and at least one of the standard diagrams.

6. The method according to claim 2, wherein determining whether specified features are repeated in a specified number of diagrams, is executed by comparing a plurality of diagrams to detect a plurality of graphical features that reoccur in a number of diagrams beyond a specified threshold.

7. The method according to claim 2, wherein determining whether the diagram graphically relates to other diagrams is executed by comparing at least two diagrams associated with a common artifact to detect a graphic reference from at least one diagram to another diagram.

8. A system comprising:
an input unit configured to obtain a plurality of artifacts, wherein each one of the artifacts exhibits at least one diagram, and wherein at least some of the artifacts exhibit text associated with the diagrams;
a factor determinator configured to determine, for each diagram, a plurality of specified factors; and
an estimator configured to estimate, for each diagram, a likelihood of the diagram being a conceptual model based at least partially on the determined factors,
wherein at least one of: the input unit, the factor determinator, and the estimator are in operative association with at least one processor.

9. The system according to claim 8, wherein the specified factors comprise at least one of: whether the diagram is associated with a method, whether the diagram is a deviation from a specified standard diagram, whether specified features are repeated in a specified number of diagrams, and whether the diagram relate to other diagrams.

10. The system according to claim 8, further comprising a scorer configured to apply a scoring function to the determined factors, to yield a score, and wherein the estimator is further configured to base the estimation on the score.

11. The system according to claim 8, wherein the determining whether the diagram is associated with a method, is executed by analyzing the text associated with the diagram on a common artifact to detect textual reference to the diagram associated with a specified logic or a flow.

12. The system according to claim 9, wherein the determining whether the diagram is a deviation from a specified standard diagram, is executed by comparing the diagram with a knowledge base of standard diagrams to detect consistent graphic transformation between the diagram and at least one of the standard diagrams.

13. The system according to claim 9, wherein the determining whether specified features are repeated in a specified number of diagrams, is executed by comparing a plurality of diagrams to detect a plurality of graphical features that reoccur in a number of diagrams beyond a specified threshold.

14. The system according to claim 9, wherein the determining whether the diagram graphically relates to other diagrams is executed by comparing at least two diagrams associated with a common artifact to detect a graphic reference from at least one diagram to another diagram.

15. A computer program product, the computer program product comprising:
a computer readable storage medium having computer readable program embodied therewith, the computer readable program comprising:
computer readable program configured to obtain a plurality of artifacts, wherein each one of the artifacts exhibits at least one diagram, and wherein at least some of the artifacts exhibit text associated with the diagrams;
computer readable program configured to determine, for each diagram, a plurality of specified factors; and
computer readable program configured to estimate, for each diagram, a likelihood of the diagram being a conceptual model based at least partially on the determined factors.

16. The computer program product according to claim 15, wherein the specified factors comprise at least one of: whether the diagram is associated with a method, whether the diagram is a deviation from a specified standard diagram, whether specified features are repeated in a specified number of diagrams, and whether the diagram relate to other diagrams.

17. The computer program product according to claim 15, further comprising computer readable program configured to apply a scoring function to the determined factors, to yield a score, and wherein the computer readable program configured to estimate is further configured to base the estimation on the score.

18. The computer program product according to claim 15, wherein the computer readable program configured to determine whether the diagram is associated with a method, is executed by analyzing the text associated with the diagram on a common artifact to detect textual reference to the diagram associated with a specified logic or a flow.

19. The computer program product according to claim 16, wherein computer readable program configured to determine whether the diagram is a deviation from a specified standard diagram, is executed by comparing the diagram with a knowledge base of standard diagrams to detect consistent graphic transformation between the diagram and at least one of the standard diagrams.

20. The computer program product according to claim 16, wherein the computer readable program configured to determine whether specified features are repeated in a specified number of diagrams, is executed by comparing a plurality of diagrams to detect a plurality of graphical features that reoccur in a number of diagrams beyond a specified threshold.

21. The computer program product according to claim 16, wherein the computer readable program configured to determine whether the diagram graphically relates to other diagrams is executed by comparing at least two diagrams associated with a common artifact to detect a graphic reference from at least one diagram to another diagram.
